(19) United States
(12) Patent Application Publication
(10) Pub. No.: US 2007/0193607 A1
(43) Pub. Date: Aug. 23, 2007

(54) METHODS AND APPARATUS FOR CLEANING EDGES OF A SUBSTRATE

(76) Inventors: John Ghekiere, Kalispell, MT (US); Aaron W. Arvidson, Kalispell, MT (US); Bruce Fender, Kalispell, MT (US); Craig P. Meuchel, Kalispell, MT (US); Raoul Schroder, Dresden (DE); Brian Aegerter, Kalispell, MT (US); Ron Flink, Dresden (DE); Jason Rye, Kalispell, MT (US)

Correspondence Address: PERKINS COIE LLP/SEMITOOL, PO BOX 1208, SEATTLE, WA, 98111-1208, US

(21) Appl. No.: 11/739,201

(22) Filed: Apr. 24, 2007

Related U.S. Application Data
(63) Continuation-in-part of application No. 11/359,969, filed on Feb. 22, 2006.

(51) Int. Cl. C23G 1/00; B08B 3/00; B08B 7/00

(52) U.S. Cl. 134/33; 134/34; 134/26; 134/2; 134/94.1; 134/103.2; 134/137

(57) ABSTRACT

In methods and apparatus for cleaning a wafer, a cleaning liquid is sprayed or jetted in a direction generally tangent to the circular edge of a spinning wafer. This enhances removal of contaminants from areas near the edge. Re-deposition of contaminant pieces or particles back onto the wafer is reduced because the direction of the spray carries the contaminant off of the wafer. Insoluble contaminant films, such as post etch residue, may be removed via one or more of the pressure of the cleaning liquid, the effects of higher process temperatures from heating the cleaning liquid, and by the chemical composition of the cleaning liquid.

### PRIORITY CLAIM

This Application is a continuation-in-part of U.S. patent application Ser. No. 11/359,969, filed Feb. 21, 2006 and now pending and incorporated herein by reference.

### BACKGROUND

Remarkable progress made in microelectronic devices over the past several years has led to more useful yet less expensive electronic products of all types. It has also led to entirely new types of products. A major factor in the development of microelectronic devices has been the machines and methods used to manufacture them. Manufacturing of microelectronic devices requires extreme precision, extremely pure materials, and an extremely clean manufacturing environment. Even microscopic particles can cause defects and failures in devices.

Microelectronic devices are typically manufactured by selectively applying and removing various layers or films of material onto a substrate, such as a silicon wafer. Manufacturing by-products, such as polymer, post etch plasma residue, and other contaminants on the wafer after certain process steps, must be removed before the wafer is further processed. These types of contaminants can be difficult to completely remove. Some contaminants are only minimally soluble with preferred aqueous cleaning solutions. Other contaminants become tightly bonded to an underlying layer on the wafer and are difficult to remove. Some contaminants also tend to re-adhere to the wafer surface after they are initially removed during the cleaning process. Developing effective ways to remove contaminants remains as a technological challenge in semiconductor device and other micro-scale device manufacturing.

### SUMMARY OF THE INVENTION

New cleaning apparatus and methods provide significantly better results with difficult to remove contaminants. The contaminants can now be more quickly and easily removed using lower cost and more environmentally friendly cleaning solutions. In one aspect, the cleaning liquid is sprayed or jetted in a direction generally tangent to the circular edge of a spinning workpiece, enhancing removal of contaminants from areas near the edge. In another aspect, the contaminant is removed via the pressure of the cleaning liquid, the temperature of the cleaning liquid, the chemical composition of the cleaning liquid, or a combination of them.

### BRIEF DESCRIPTION OF THE DRAWINGS

In the drawings, the same reference number indicates the same element in each of the views.

FIG. 1 is a perspective view of a new processor.

FIG. 2 is a perspective view of a first side of the base of the processor shown in FIG. 1.

FIG. 3 is a perspective view of the other side of the base shown in FIG. 2.

FIG. 4 is a section view of the processor shown in FIG. 1.

FIG. 5 is a front view of the nozzle block shown in FIG. 2.

FIG. 6 is a top view of the nozzle block shown in FIG. 5.

FIG. 7 is a bottom view of the nozzle block shown in FIG. 5.

FIG. 8 is a perspective view of the nozzle block shown in FIGS. 5-7.

FIG. 9 is section view taken along line 9-9 of FIG. 6.

FIG. 10 is a section view taken along line 10-10 of FIG. 5.

FIG. 11 is a schematic top view section of the processor shown in FIGS. 1-3.

FIG. 12 is a perspective view of a processing system.

FIG. 13 is a top view of the processor array in the processing system in FIG. 12.

### DETAILED DESCRIPTION OF THE DRAWINGS

The invention is directed to apparatus and methods for processing or cleaning a workpiece, such as a semiconductor wafer. The term workpiece or wafer here means any flat article, including semiconductor wafers and other substrates such as glass, mask, and optical or memory media, MEMS substrates, or any other workpiece having, or on which, microelectronic, micromechanical, microelectro-mechanical or micro-optical devices can be formed. The term contaminant here means any unwanted particles, film or other material on a wafer.

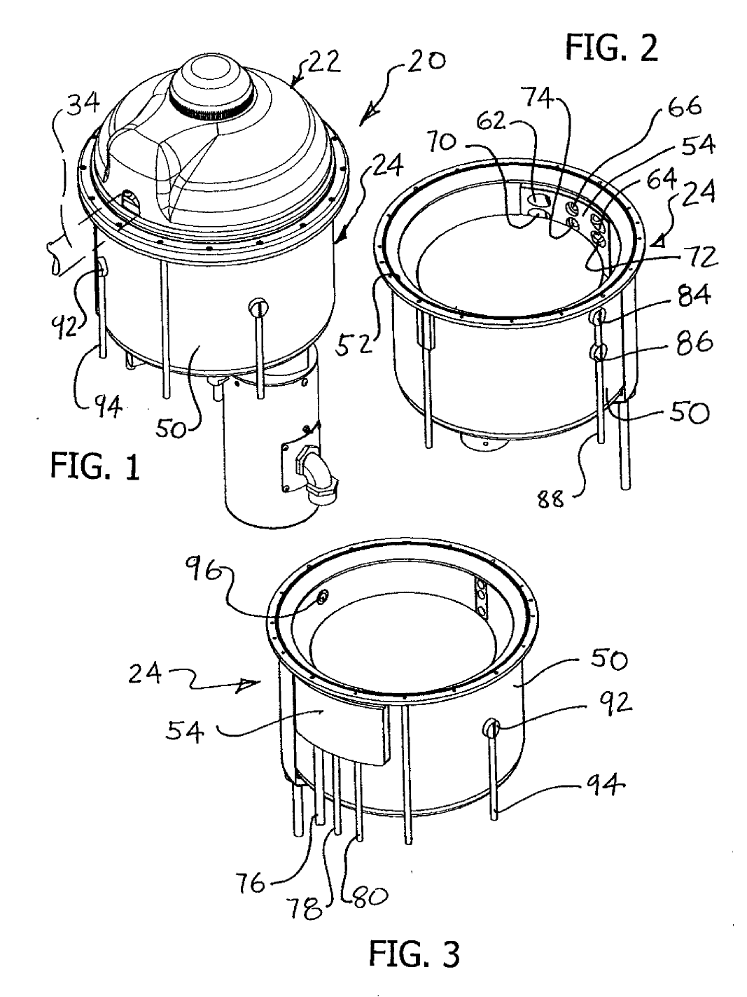

Turning now to FIGS. 1-3, a processor 20 has a head 22 which may be moved into and out of engagement with a base 24. The base 24 includes a bowl 50 which may have generally cylindrical side walls.

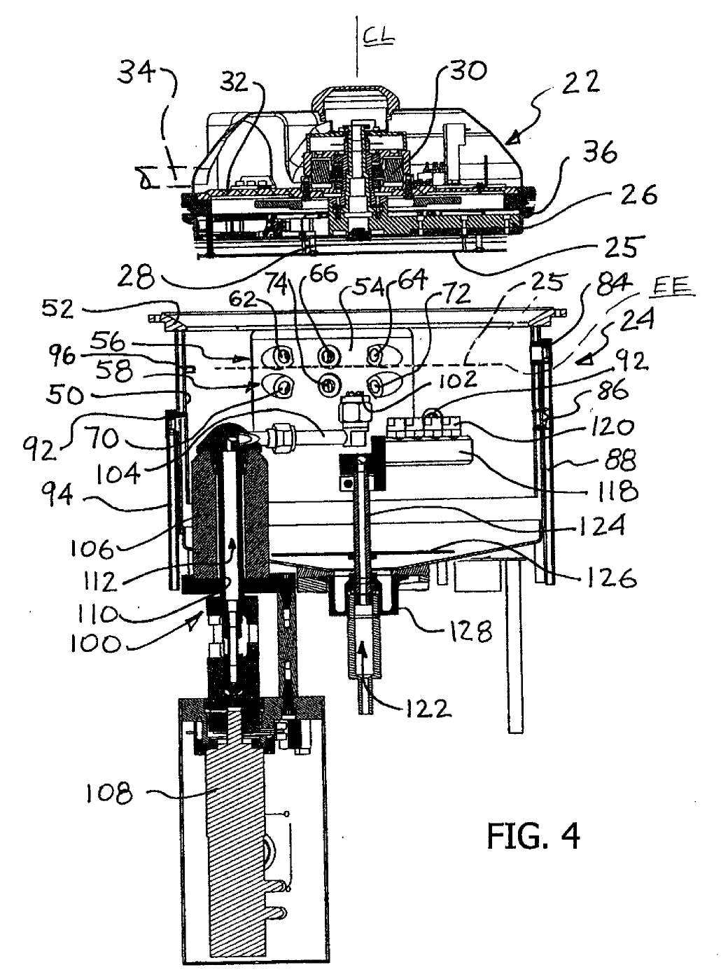

Turning to FIG. 4, the head 22 typically includes a rotor 26 rotatably supported by a head frame 32. A motor 30 in the head 22 is adapted to spin the rotor 26. Fingers or retainers 28 on the rotor 26 hold a wafer 25. An arm 34 attached to the head frame 32 may be raised and lowered, and optionally also rotated to invert the head 22, by a head lifter (not shown). A rim 36 on the head 22 may be designed to engage and optionally seal against a base rim 52 on the base 24. As shown in FIG. 4, the bowl 50 preferably has a sloped bottom surface to allow liquids to collect in a sump 128, leading out to a liquid drain. A sump plate 126 may be raised above the floor of the bowl 50.

FIGS. 1 and 4 show one example of a head 22. Various other types of heads may be used, for example, the head as described in U.S. patent application Ser. No. 11/619,515 or U.S. patent application Ser. No. 11/359,969, both incorporated herein by reference. FIG. 1 shows the processor 20 in a processing position, with the head 22 engaged onto the base 24. FIG. 4 shows the head 22 spaced apart above the base 24, in an intermediate position.

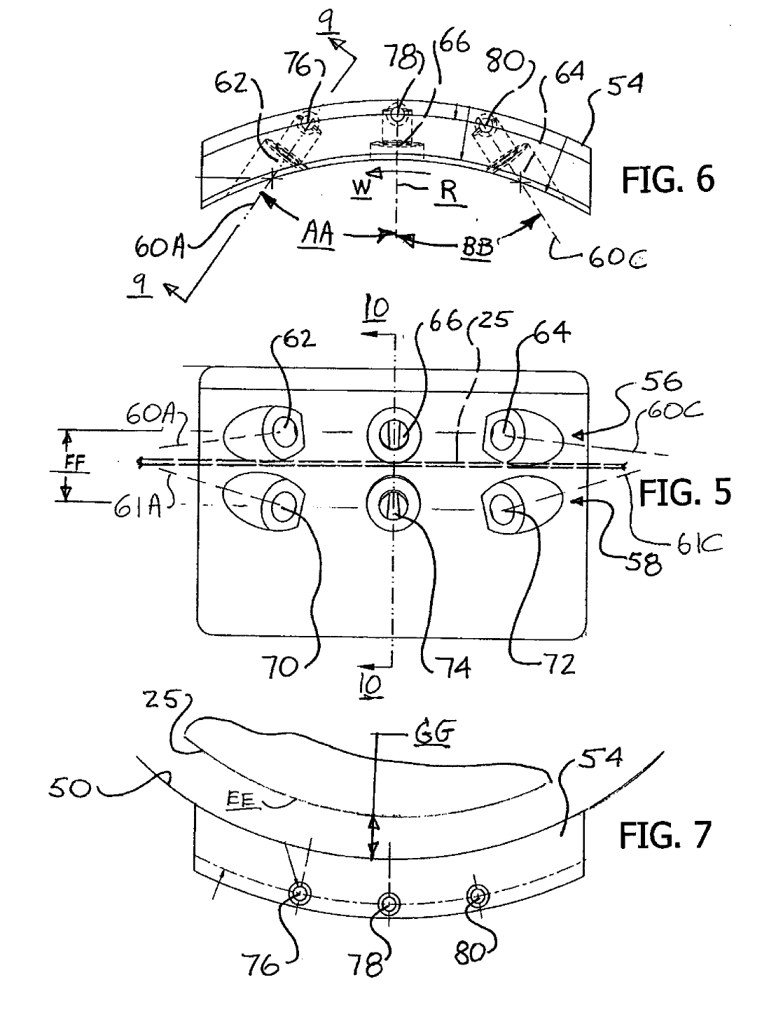

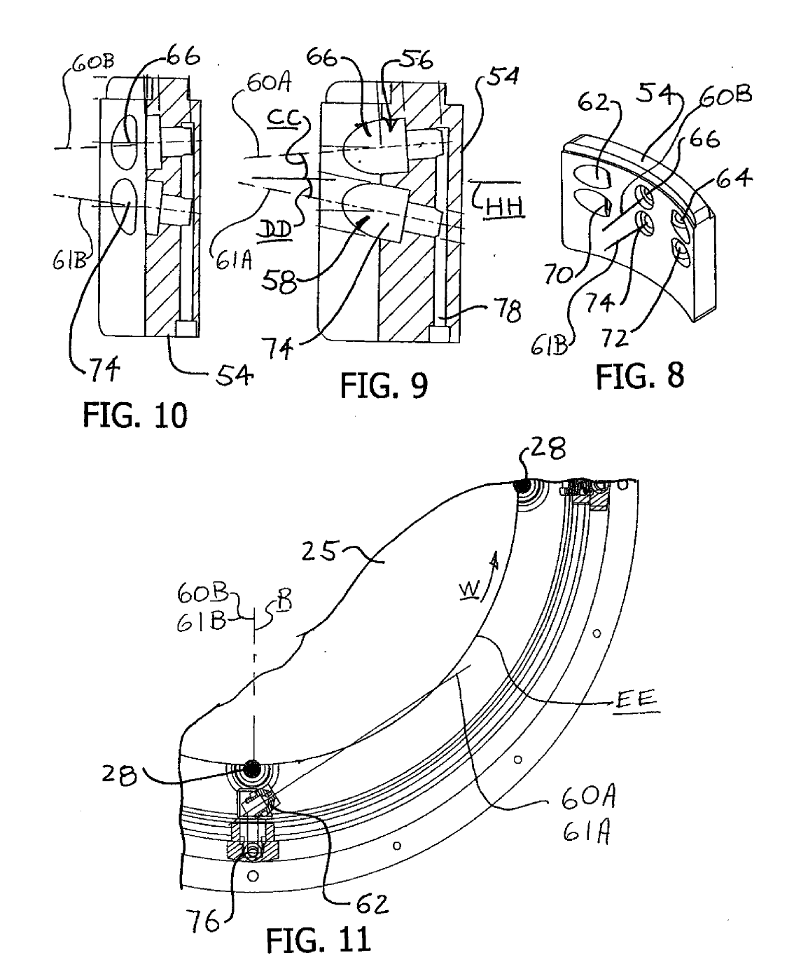

As shown in FIGS. 2 and 4, side spray nozzles 62, 64, 66, 70, 72, and 74 are provided in or on a sidewall of the base 24. These side nozzles may be provided in a nozzle block or manifold 54, which is separately shown in FIGS. 5-10. Alternatively, they may be provided as separate nozzles. Referring to FIGS. 4 and 5, the side nozzles may be arranged in an upper row 56 and a lower row 58. With the wafer 25 in the processing position, as shown in dotted lines in FIGS. 4 and 5, the upper row 56 is slightly above the top surface of the wafer 25 and the lower row 58 is slightly below the bottom surface of the wafer 25. The spacing FF in FIG. 5 between the centerlines of the top and bottom rows (and the nozzles in them) is advantageously about 15 to 25 mm. Accordingly, the side nozzles are close (within 10 to 15 mm) to the wafer surfaces, in the vertical direction. While FIGS. 4 and 5 show the plane of the position the wafer 25 as closer to the upper row of nozzles 56, the vertical spacing between the wafer 25 and the nozzles may be varied.

As shown in FIG. 9, the side nozzles 62, 64, and 66 in the upper row 56 are aimed slightly downwardly at an angle CC to the horizontal plane HH. The center line or central axis 60A, 60B and 60C of the nozzles 62, 64 and 66 in the upper row 56 form a vertical declination angle CC with a horizontal line or plane HH. The angle CC typically ranges from 2-10°, or 3-7°, or about 5°.

Referring still to FIG. 9, the side nozzles 70, 72, and 74 in the lower row 58 are angled slightly upwardly at a vertical inclination angle DD to the horizontal plane HH. In other words, the center line or central axes 61A, 61B and 61C of the nozzles in the lower row 50A form an angle DD with a horizontal plane HH, with angle DD typically ranging from about 5-15° or 8-12°, or about 10°, In the specific design shown, angle CC is the same for all side nozzles in the upper row, in this case nozzles 62, 64 and 66, and angle DD is the same for all side nozzles in the lower row, in this case side nozzles 70, 72 and 74. However, the side nozzles within each row may have differing vertical declination or inclination angles CC and DD. For example, the side central nozzles 66 and/or 74 may be oriented at smaller or flatter angles, to project liquid more towards the center of a wafer in the rotor. The side nozzles also need not necessarily be arranged in a row. Rather the vertical position of any side nozzle may be varied, along with its declination or inclination angle, in different applications.

Referring to FIGS. 5, 6, 8 and 10, side central nozzles 66 and 74 are aimed along axes 60B and 61B, respectively radially towards a center line CL of the rotor 26, and at declination and inclination angles CC and DD, respectively. With a wafer 25 centered in the rotor 26, the line CL is also the center line of the wafer 25. As shown in FIGS. 5, 6, 8, and 11, side nozzles 62 and 70 are aimed in azimuth to provide a spray or jet which is generally tangent to the edge of the wafer 25. Generally tangent here means within 5, 10, 15 or 20° of tangent. Referring to FIG. 6, the central line or axis 60A of the nozzle 62 is oriented at a trailing angle AA from a radius R of the rotor 26. (The radius R extends in the same direction as lines 60B and 61B).

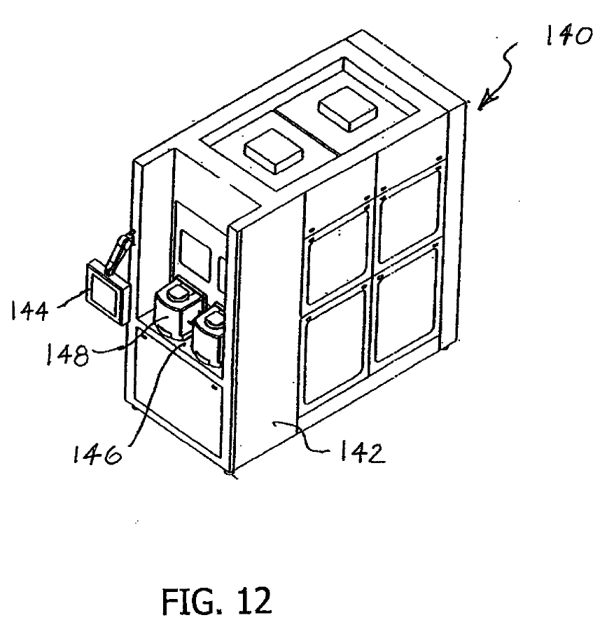

Referring to FIG. 11, the nozzles 62 and 70 are aimed so that the lines 60A and 61A are generally tangent to the edge EE of the wafer 25. For a rotor 26 adapted to hold a 200 millimeter diameter wafer 25, and with the nozzles spaced apart from the edge of the wafer as shown in FIGS. 7 and 11, the angle AA is typically about 20-50, 25-45, 30-40 or about 35 degrees. The orientation of the nozzles 64 and 72 may be substantially a mirror image of the orientation of the nozzles 62 and 70. Specifically, the lines 60C and 61C, which define the azimuth direction of the nozzles 64 and 72, may form an angle BB with a radius R of the rotor 26, as shown in FIG. 6. With this design, the nozzles 64 and 72 are aimed at the advancing edge EE of the wafer 25. In FIG. 7, the inside face of the nozzle block 54 (if used) is shown as generally flush with the inside cylindrical side wall of the bowl 50. In this design, the radial spacing GG in FIG. 7 between the side nozzles (which are essentially co-planer with the bowl side wall) and the edge of the wafer 25 is typically about 10-20, 12-18, or 14-16 mm. In some applications, the side nozzles may be set back or recessed into the bowl sidewall, or extended out to a position closer to the wafer. Accordingly, the side nozzles need not necessarily even be mounted in or on the bowl side wall, or in a clustered pattern as shown in FIG. 5.

The specific angles described above may vary with different applications. In many applications, only the trailing side nozzles 62 and 70 may be used, with or without the central nozzles 66 and 74, or alternatively, the leading side nozzles 64 and 72 may be used with the central nozzles 66 and 74. In fewer circumstances, both trailing nozzles such as 62 and 70, and the leading side nozzles such as 64 and 72, may be used in the same process.

The angles described above can vary depending upon the diameter of the rotor and wafer, as well as the dimensions between the nozzles and the wafer position in the rotor. Various types of nozzles may be used, such as cone pattern spray nozzles, fan pattern spray nozzles or needle jet nozzles. A jet is a substantially continuous column of moving liquid, in contrast to a spray which is formed from discrete droplets. While the drawings show six nozzles 62, 64, 66, 70, 72, and 74, of course, different numbers of each type of nozzle (declined, inclined, leading, trailing, or central) may be used. The location of the nozzles may also be varied to the extent that the sprays or jets from the nozzles do not excessively interfere with each other.

Referring to FIGS. 3 and 7, supply lines 76, 78, and 80 provide process or cleaning liquids to the side nozzles. In many applications, the same liquid may be applied to the top and bottom surfaces of the wafer 25. In this case, all of the side nozzles may be supplied with the same liquid, optionally from one or more supply line. In some applications, different liquids may be applied to the top and bottom surfaces of the wafer 25. In this case, each of the side nozzles in the upper row 56 may be provided with one type of liquid from a supply line 76, 78, or 80, while the side nozzles in the lower row 58 are supplied with a different liquid. It is also possible to provide sufficient liquid supply lines so that individual nozzles within either row 56 or 58 may be provided with a liquid different from other nozzles in the same row. For example, trailing side nozzles 62 and 70, and leading side nozzles 64 and 72, may be provided with a cleaning solution including heated de-ionized water and a detergent or surfactant, while the central side nozzles 66 and 74 are provided only with heated de-ionized water.

Referring once again to FIG. 4, in many applications, the base 24 may include moving nozzles, such as on a swing arm assembly 100. The swing arm assembly 1007 if used, has one or more nozzles 102 on a swing arm 104 supported on a stand 106. A motor 108 drives a shaft 110 attached to the swing arm 104, causing the swing arm 104 to swing back and forth through an arc. This provides for more uniform distribution of fluid onto the bottom surface of the wafer 25. A fluid supply line 112 leading to the nozzles 102 may provide for a high pressure spray against the bottom surface of the wafer 25.

Additional fixed nozzles may also be provided in the base 24 to spray the bottom or down facing side of the wafer 25. As shown in FIG. 4, additional nozzles 120, if used, may be provided on a manifold 118 mounted on a post 124. The post 124 and manifold 118, if used, are positioned in the base 24 to avoid interfering with the swing arm 104. A fluid supply line 122 supplies fluid to the nozzles 120. The fixed in place nozzles 120 may be used with or without the swing arm assembly 100, and vice versa.

Additional nozzles or outlets may also optionally be provided in the base 24. For example, one or more high pressure edge-on nozzles 96 may be generally vertically aligned with the edge of the wafer 25 (when the wafer 25 and head 22 are in the processing position). If used, the edge-on nozzles 96 may be directed radially inwardly towards the center of the rotor 26. The jet or spray from the edge-on nozzle 96 impacts at the edge of the wafer, where it may more easily penetrate under certain contaminant layers.

A jet or spray from a leading or trailing nozzle tends to carry removed contaminant particles off of the wafer. In contrast, a jet or spray from an edge-on nozzle tends to carry removed contaminant particles inwardly towards the center of the wafer. This is often acceptable with contaminants that do not re-adhere to the wafer. For removing re-adhering contaminants, edge-on nozzles may be successfully used, with other nozzles providing sufficient liquid onto the wafer to maintain an outward flow across the wafer, to prevent re-adhesion.

As shown in FIG. 4, one or more rotor rinse nozzles 84 and one or more chamber rinse nozzles 86 may also optionally be provided in the base 24. If used, theses nozzles may be supplied with a rinse or other liquid from supply line 88.

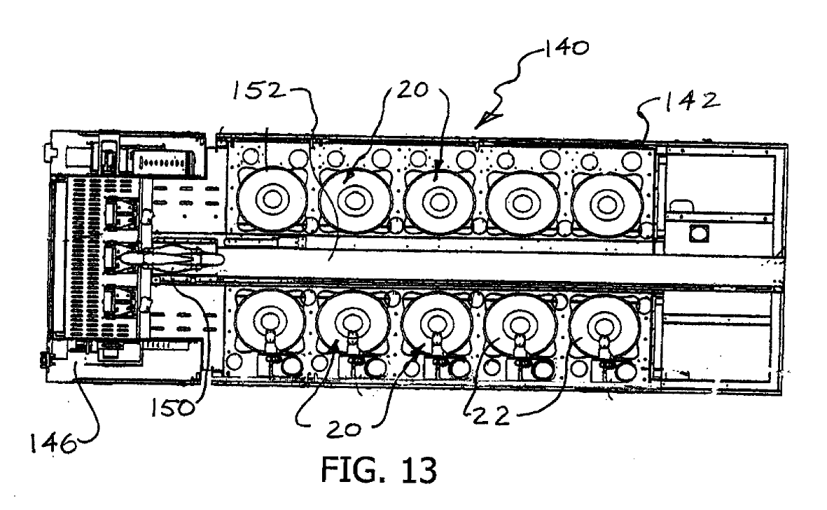

FIGS. 12 and 13 show a system 140 which may include one or more of the processors 20. In the example shown in FIGS. 12 and 13, multiple processors 20 are arranged in rows within an enclosure 142 of the system 140. As shown in FIG. 12, a controller 144 may be provided to monitor and control operations of the system 140. The system 140 may include an input/output or docking station 146. In this type of system, wafers 25 are moved to the input/output station 146 within containers 148. A robot 150, as shown in FIG. 13, is movable within the system 140 to carry wafers 25 from the containers 148 to one or more processors, and then back into a container. The system 140 may be designed and operate as described in International Application PCT/US04/17760, incorporated herein by reference. In other types of systems, the processors 20 may be arranged on a circle, an arc, in a cross shape, or in other configurations, and with varying numbers of processors 20 or robots included.

In use, a wafer 25 is loaded into the head 22 and secured by the fingers 28 or other equivalent wafer holding devices. The head 22 may be inverted, i.e., in an upside down orientation, during wafer loading/unloading. If the processor 20 is used in a system 140, the handling of the wafer 25 may be computer controlled via the controller 144 and robot 150.

The head 22 is lowered into engagement with the base 24. The head rim 36 may engage the base rim 52, to align the head and base, provide a precise position for the wafer during processing, and/or to seal the bowl 50, to prevent escape of liquids, vapors, or gases.

The motor 30 is switched on and spins the rotor 26. If used, the swing arm assembly 100 is activated, with the motor 108 driving the swing arm 104 back and forth. Fluid is sprayed or jetted onto the spinning wafer 25 from the nozzles 102 on the swing arm 104, and from one or more of the nozzles 62, 64, 66, 70, 72 and 74. In addition, fluid may be sprayed or jetted from the fixed lower nozzles 120, if used. In certain processing steps, the edge-on nozzles may also be used.

In a typical application, the wafer 25 is a silicon wafer with partially completed semi-conductor devices fabricated on one device side, and no devices on the back side. In this example, contamination is targeted for removal from the backside near and at the edge EE of the wafer 25 (including the bevel), from the flat outer edge of the wafer (if present) and from the bevel area on the device side of the wafer.

The nozzles 102 on the swing arm 104 spray a process liquid at high pressure, e.g., 300 psi to 2500 psi or higher, or 1000-2000 or 1200-1800 psi, onto the backside of the wafer 25. The swing arm 104 swings back and forth across the area of the wafer 25 having the contamination to be removed. The nozzles 102 on the swing arm 104 may be oriented perpendicular to the wafer 25. However, they may also be angled outwardly towards the edge of the wafer. In this case, especially where bulk contamination is not dissolved in the process liquid, the process liquid tends to more readily undercut the contamination, while also reducing or eliminating re-adhesion of the contamination on the wafer surface.

Before, with, or after application of the process liquid from the swing arm 104, process liquid may also be sprayed or jetted from one or more of nozzles 62, 64, 70, or 72 in a direction generally tangent to the edge of the wafer, to remove contamination from the edge and bevel and surrounding wafer surfaces. A relatively high pressure jet or spray, e.g., about 300-800, 400-700, or 500 psi, from the nozzles 62, 64, 70 or 72, can tend to cause contaminant films at the edge of the wafer 25 to loosen and lift off the wafer, with the process liquid penetrating beneath the film. This tangential spray or jet of process liquid reduces or eliminates re-adhesion of loosened contamination particles, because the direction of the process liquid tends to carry the contaminant particles off of the surface of the wafer 25. Process liquids may also simultaneously be sprayed towards the center of the top or device side of the spinning wafer 25 from the nozzles 66 and 74, to help to reduce or avoid re-adhesion of contaminate particles up by creating a net movement of process liquid across the wafer surface, towards the edge of the wafer.

The process liquid delivered onto the wafer from any of the nozzles may include a heated mixture of deionized water. Additives may be used including surfactants, detergents, alcohols or co-solvents, chelating agents, or combinations of them, for removing contamination from the backside of the wafer. The tangential nozzles 62, 64, 70, or 72 may also operate at high pressures, up to 1500 or 2000 psi, but more generally operate at pressures of about 300-700 or 400-600 psi, providing a spray or a jet.

On the backside of the wafer, the film of contamination tends to be penetrated by the spray of process liquid at several locations. Penetration of the contamination film is enhanced by heating the liquid, and the pressure or impact of the liquid on the film. The contaminant film on the backside of the wafer is typically also undercut, via the physical effects of the heat and pressure of the liquid, and the chemical effects of the additive. The process liquid, such as deionized water and a surfactant or detergent additive, may be heated to 25 or 30° C.-99° C., and typically to about 85-99° C. To avoid adverse heat related affects with some types of wafers, the process may also be performed at room temperature.

Since a process liquid made up of de-ionized water and a detergent or surfactant is relatively low cost, it may be applied in a single use system, where the process liquid is used and then not reclaimed or recirculated. Where the contaminants are largely insoluble, single use avoids the collection of the contaminant material in the process liquid system. As a result, maintenance of the system to remove the contamination is avoided, and the potential for recontamination via use of reused process liquid is avoided.

Referring to FIG. 11, with the wafer 25 spinning in the direction W, since the edge EE of the wafer 25 is generally moving in the same direction as the jet or spray from the trailing nozzle 62 and/or nozzle 70, the physical impact of the liquid from the nozzle 62 is reduced. On the other hand, if the leading nozzles 64 and/or 72 are used, the edge of the spinning wafer 25 is moving into the jet or spray, adding to the physical impact of the liquid onto the contaminant on the wafer. Ordinarily, this increased impact can provide improved cleaning, such that the leading nozzles 64 and 72 may provide advantageous results. However, with some contaminants, use of leading nozzles, such as nozzles 64 and 72, especially with high pressures, may cause excessive scattering and re-deposition of contaminant particles. Accordingly, where excessive re-deposition is significant, such as with certain largely insoluable films which tend to be removed in larger particles or pieces, the leading nozzles such as 64 and 72, may be omitted.

The processor 20 is especially useful for removing insoluable contaminant films, such as post-etch residues. These films may have carbon HF bonds which do not dissolve. Accordingly, the processor 20 removes the contaminant film via the use of impact of the process liquid against the contaminant layer, penetration of the layer, and optionally via use of heat and chemical additives, such as surfactants or detergents. These additives, if used, help to keep the surface of the wafer wet, which aids in preventing redeposition of the contaminant particles.

The methods and apparatus described above may be used in removing metallic contamination from a workpiece. For example, during electro less nickel/lead (Ni/Pb) wafer plating processes, some nickel tends to plate out on the edge and bevel of the wafer. This nickel is not plated onto the device area of the wafer. Accordingly, it is generally only loosely attached to the surface of the wafer and tends to flake off the edge and bevel, in the form of whiskers or stringers. These whiskers can contaminate the wafer and the wafer handling and processing equipment. The whiskers may be removed by delivering a high pressure jet or spray of liquid to the bottom or back side edge of the spinning wafer, preferably at an acute angle to the wafer.

Referring to FIG. 4, this may be achieved with the nozzle(s) 102 on the swing arm 104 oriented at an acute angle to the plane of the wafer. The swing arm may be held in a position near the edge of the wafer, with the high pressure liquid moving upwardly and radially outwardly from the nozzle(s) 102 to the edge area of the spinning wafer. In some applications, the swing arm may also swing slightly, with e.g., 1-10 mm of movement. Other nozzles e.g. nozzles 66 may provide a lower pressure, larger volume or flood of liquid onto the top surface of the wafer. The resulting radially outward flow of liquid on the top surface of the spinning wafer tends to prevent re-adhesion of whiskers on the top surface. The vertical and horizontal position of the swing arm 104 may be adjusted to select the acute angle of impact of the liquid against the wafer edge. In this process, the tangent nozzles 62 or 64 may or may not also be used.

The whisker removal process may also be performed using a fixed high pressure nozzle, such as a nozzle 120 on the manifold 118, or another nozzle fixed in position elsewhere in the process chamber, below the wafer. Whether the whisker removal nozzle(s) are fixed or moveable, orienting the nozzle to apply liquid an acute angle to the edge allows the whiskers to be removed, and also tends to carry the removed whiskers off of and away from the wafer. Experimental results have demonstrated however that the whiskers may also be removed with nozzles spraying at the edge of the wafer, at substantially a right angle to the plane of the including de-ionized water, with or without any additional process chemicals. The liquid may be heated or used at room temperature.

While the processor 20 is shown as a single wafer processor, the techniques described here may also be used in batch processors. As used here, edge area means the annular area extending inwardly about 20, 10, 8, 5, 4, 3, 2 or 1 mm from the edge of the workpiece.

Thus, novel apparatus and methods have been shown and described. Various changes and substitutions of equivalents may of course be made, without departing from the spirit and scope of the invention. The invention, therefore, should not be limited, except by the following claims and their equivalents.

1. A method for cleaning a workpiece comprising:
spinning the workpiece;
spraying a first process liquid onto a first side of the workpiece, in a first direction generally tangent to an edge of the workpiece;
spraying a second process liquid onto a second side of the workpiece, substantially also in the first direction; and
applying the first process liquid onto the first side of the workpiece at a position on the first side of the workpiece at or adjacent to a center of the workpiece, or between the edge of the workpiece and the center of the workpiece.

2. The method of claim 1 further comprising heating at least one of the first and second process liquids to 50-99° C.

3. The method of claim 1 with at least one of the first and second process liquids including an additive.

4. The method of claim 3 wherein the additive comprises a surfactant.

5. The method of claim 1 further comprising spinning the workpiece in the first direction.

6. The method of claim 1 further comprising applying the second process liquid onto the second side of the workpiece from one or more high pressure nozzles on a swing arm.

7. The method of claim 1 further comprising applying the second process liquid onto the second side of the workpiece from a plurality of high pressure nozzles fixed in a position below the workpiece.

8. The method of claim 1 wherein the first process liquid is the same as the second process liquid.

9. A method for removing a contaminant from a workpiece, where the contaminant is substantially insoluble in water, comprising:
spinning the workpiece;
directing a first spray of liquid onto a first side of the workpiece, in a direction generally tangent to an edge of the workpiece;
directing a second spray of liquid onto a second side of the workpiece, in a direction generally tangent to an edge of the workpiece;
directing a third spray of liquid onto a central area of the first side of the workpiece;
directing a fourth spray of liquid onto a central area of the second side of the workpiece; and
removing the substantially water insoluble contaminant from the workpiece.

10. The method of claim 9 wherein at least the first and second sprays comprise water and a surfactant.

11. The method of claim 9 wherein at least the first and second sprays comprise a liquid heated to 30-99° C.

12. The method of claim 9 wherein the substantially water insoluble contaminant is removed in macroscopic pieces.

13. The method of claim 9 with the first and second sprays at a pressure of 300-600 psi.

14. The method of claim 9 with the fourth spray at a pressure of 1000-2500 psi.

15. The method of claim 9 wherein the contaminant comprises a residue resulting from plasma etching a low-K film.

16. The method of claim 9 with the edge of workpiece generally moving away from the first and second sprays, and further comprising:
directing a fifth spray of liquid onto the first side of the workpiece, in a direction generally tangent to the edge of the workpiece; and
directing a sixth spray of liquid onto the second side of the workpiece, in a direction generally tangent to the edge of the workpiece, and with the edge of the workpiece generally moving into the fifth and sixth sprays of liquid.

17-22. (canceled)

23. A method for removing metal contamination from the edge of a workpiece comprising:
spinning the workpiece;
projecting a high pressure liquid at an edge area of a first side of the workpiece, at an acute angle to the workpiece, with the high pressure liquid impacting and physically removing the metal contamination from the edge of the workpiece; and
applying a second liquid onto a second side of the workpiece, with the second liquid covering substantially the entire second side of the workpiece and moving outwardly and off of the workpiece via centrifugal force, with the second liquid substantially preventing re-deposition of the metal contamination on the second side of the workpiece.

24. The method of claim 23 wherein the metal contamination comprises nickel whiskers resulting from a nickel/lead plating process.

25. The method of claim 23 with the high pressure liquid supplied from one or more nozzles on a moveable spray arm.

26. The method of claim 23 wherein the wafer is spinning in substantially horizontal plane, and with first side of the wafer facing downwardly.
